(19) United States
(12) Patent Application Publication
(10) Pub. No.: US 2003/0123546 A1
(43) Pub. Date: Jul. 3, 2003

(54) Scalable multi-level video coding

(75) Inventors: Yohai Falik, Ra'anana (IL); Assaf Siani, Bney-Brak (IL); Aharon Vozovoy, Ra'anana (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: EMBLAZE SYSTEMS

(21) Appl. No.: 10/209,889

(22) Filed: Aug. 2, 2002

Related U.S. Application Data
(60) Provisional application No. 60/342,859, filed on Dec. 28, 2001.

(51) Int. Cl. H04N 7/12

(52) U.S. Cl. 375/240.12; 375/240.03; 375/240.01; 375/240.24

(57) ABSTRACT

A method for streaming video in a varying bandwidth through scalable multi-level video coding, including: providing at least two compressed video streams, each stream including a respective plurality of Inter-frames; encoding at least one Inter-frame of each respective plurality at a respective quantization using an Intra-Block Refresh mechanism; creating at least one switch frame between any pair of the compressed video streams; and creating a mixed stream using any pair of compressed streams and the at least one switch frame.

### CROSS-REFERENCE TO RELATED APPLICATIONS

This application is entitled to the benefit of priority from U.S. Provisional Application No. 60/342,859 filed Dec. 28, 2001.

### FIELD AND BACKGROUND OF THE INVENTION

A movie is a set of consecutive (stills) pictures, which are rendered on the screen at high speed giving the illusion of movement, each picture (when referred to a movie) called a frame. Video coding is a collection of algorithms and methods used to compress the movie to a size that fits the bits budget—the “bit-rate”, which is determined by the delivery medium. For example, a local network communication wire can deliver a movie at a constant rate of 10 megabits per second (Mbps) A cellular network can deliver a much lower bit-rate.

There are (usually) two software components involved with multimedia coding: an encoder and a decoder. The encoder is the component that takes the raw data and compresses it to a compact size for delivery. As expected, the smaller the result (the larger the compression), the lower the picture quality one gets. The decoder is the component that receives the compressed data, and decompresses it.

In order to save bits, most video coders use the fact that there is usually little difference between consecutive frames. This fact is exploited by encoding only the differences, having the decoder render a full picture from the previous frame with the additional difference information. When a frame is based on a former frame, which is itself based on a former frame, a single frame—the first one—needs to be given “at full”. This “fully given” frame is named a “key-frame”, or as used in the MPEG standard as “Intra-frame” or “I-frame” for short. A frame that consists of a difference from other frame or frames is named “Inter-frame” or “difference frame”. In case the difference is only from the previous frame MPEG standard names the frame a “predicted frame” or “P-frame” for short. Normally, the encoder encodes a key-frame once every period of time, typically every few (4-10) seconds, in order to improve the picture quality of the movie, since using Inter-frames leads to degradation in the picture quality with time. When encoding a P-frame, a formerly encoded frame is called the “reference” frame, and the new picture to be encoded is called the “target” frame. A bit-stream or “stream” for short is a set of consecutive encoded frames, which is created by the encoder and delivered to the decoder.

In modern cellular networks the bandwidth available for a video stream is varying in time. In fact, the available bandwidth can change significantly through short time periods. It is desirable to exploit the available bandwidth as much as possible.

A main method for streaming stored video in a varying bandwidth includes scalable video, which means storing the video in multiple layers and transmitting the appropriate layers. Another widely used method includes switching between multiple levels of the video.

Each method has its disadvantages: scalable video should have support for multiple layers in the decoder, and this support might not be available in the coming years on future handsets and other S/W players. This method also has problems concerning complex decoder and poor video quality, due to the overhead associated with layering. The multiple levels method does not suffer from the previous disadvantages, but lacks flexibility and can only switch a stream at key-frames, which makes it very hard to use in low bandwidth. In most cases, the interval between key-frames is longer than the bandwidth variation interval, making switching streams at it key-frames almost irrelevant.

The MPEG-4 video coding standard defines two methods for scalable video, known as spatial scalability and temporal scalability. The idea behind spatial scalability is to keep additional information on every coded frame, such that when using this additional information, the frame appearance is enhanced. This additional information, named enhancement layer, is transmitted whenever enough bandwidth is available.

Temporal scalability uses additional bandwidth to transmit frames that were not coded in the base layer. When playing a movie, every second of video consists of a number of consecutive frames. The number of frames flashed to the screen per second, denoted as FPS, is usually less than optimal for the illusion of smooth natural movement. The idea behind temporal scalability is to transmit more frames whenever possible, i.e. when more bandwidth is available.

Another method is the multi-level coding, which means encoding the same video in a number of versions, with each version encoded with a different bandwidth, and switching between the versions according to the specific bandwidth available. The switching between the versions can only be done at key-frames, which are not dependent on other frames.

For interactive video storage applications that retrieve video data over low bit-rate networks, pre-coded bit-streams have to be transmitted to the receiver with low start-up times (latency). As mentioned by N. Farber and B. Girod in “ROBUST H.263 COMPATIBLE VIDEO TRANSMISSION FOR MOBILE ACCESS TO VIDEO SERVERS”, IEEE Proceedings of the International Conference on Image Processing (ICIP), volume 2, page 73, 1997, which is incorporated herein for by reference for all purposes, besides random access, fast forward and reverse, the scalability of the bit-stream is an important requirement for the above application. To avoid latency, it is undesirable to load a complete bit-stream from a remote video server before it can be displayed. Especially for PSTN or wireless networks, which are characterized by low bit-rates, the video bit-rate cannot be significantly lower than the network bit-rate, and the imposed latency by loading the complete bit-stream is prohibitive for longer sequences. In this case, video data needs to be loaded and displayed in near real-time (“video streaming”) and hence becomes more sensitive to transmission errors and delays.

In the case of video server applications, several frames of video can be buffered at the client. Therefore, longer transmission drop-outs and delays can be tolerated, allowing several retransmission attempts. However, buffer underflow cannot be avoided if the effective bit-rate of the network decreases for a longer period. In this case, the video bit-rate should be reduced to match the present network bit-rate, requiring scalability of the signal representation. Besides error robustness, the demand for interactivity like random access, fast forward, and fast reverse has to be considered. Especially for very low bit-rate video, the frequent insertion of frames encoded in Intra-frame mode (I-frames) can be prohibitive due to the significant reduction of quality at a given bit-rate. A longer interval between I-frames, on the other hand, reduces the flexibility to access the video sequence randomly.

Farber and Girod's proposed solution to the scalability problem of streaming video includes storing multiple bit-streams of different rates at the video server, which consist entirely of frames encoded in inter-frame mode (P-frames). One additional bit-stream, which consists entirely of I-frames, is stored for random access. Specially encoded P-frames (“switch frames”) are used to switch from the I-frames to the P-frames, or between P-frames of different rates. More details can be found in the reference itself.

There are a number of disadvantages to this approach, the main ones being that use of switch frames causes a severe degradation in the picture quality. A rapid use of these frames, as needed in cellular networks, will cause the video to be unusable after a few seconds. According to Farber and Girod, in order to avoid the picture degradation, an extremely large switch frame, i.e. one with a quantization parameter or “Qₚ”=1 should be used. This large switch frame, tens of times larger that an average P-frame, cannot be used to adjust a video stream to a network bandwidth, because all the available bandwidth will be taken by the switch frames, not leaving enough memory for the rest of the movie.

There is thus a widely recognized need for, and it would be highly advantageous to have, a method for scalable multi-level video coding that solves the scalability problem in streaming video without suffering from the disadvantages of prior art methods listed above.

### SUMMARY OF THE INVENTION

The present invention is of a method for scalable multi-level video coding. This method utilizes switch frames to switch between the video streams and uses a block refresh mechanism, in particular Intra-block Refresh (IBR), on the Inter-frames of the original streams, in order to decrease the propagation of errors. This method enables the use of small sized switch frames with hardly any degradation to the movie quality.

The present invention provides a method for streaming video in a varying bandwidth through scalable multi-level video coding, including at least two compressed video streams, each of which is encoded at a certain bandwidth using Intra-frames and Inter-frames such as P-frames and B-frames. A block refresh mechanism is used in the encoding process. A switch stream is created for each pair of the at least two compressed video streams. The switch stream comprises P-frames based on frames from each of the two streams, whereby the switching between the two compressed streams can be performed by using frames from the switch stream at any time at a single frame resolution, thus adjusting the streamed video to the bandwidth without degrading the video quality.

According to the present invention there is provided a method for streaming video in a varying bandwidth through scalable multi-level video coding, including: providing at least two compressed video streams, each of the at least two video streams including a respective plurality of Inter-frames; within each compressed stream, encoding at least one Inter-frame at a respective quantization using a block refresh mechanism; creating at least one switch frame between any pair of the compressed video streams; and creating a mixed stream using the pair of the compressed streams and the at least one switch frame; whereby the switching between the pair of compressed streams can be performed at any time at a single frame resolution, thus adjusting the streamed video to the bandwidth without degrading the video quality.

According to one feature of the method of the present invention, the encoding includes encoding the at least one Inter-frame using Intra-Block Refresh

According to another feature of the method of the present invention, the encoding includes encoding the at least one Inter-frame using GOB intra code in H.26L.

According to yet another feature of the method of the present invention, all the Inter-frames are encoded using Intra-Block Refresh.

According to yet another feature of the method of the present invention, all the Inter-frames are encoded using GOB intra code in H.26L.

According to yet another feature of the method of the present invention, the video streams include stored video frames.

According to yet another feature of the method of the present invention, the video streams include live video frames.

According to yet another feature of the method of the present invention, the step of providing at least two compressed video streams includes providing a first encoded stream A having a first plurality of frames, and a second encoded stream B having a second plurality of frames, and wherein the step of creating at least one switch frame between each pair of the compressed video streams includes creating a switch stream A2B between the A and B streams so that each frame in switch stream A2B at a time t represents a difference frame between a source frame from stream A and a target frame from stream B.

According to a separate embodiment of the method of the present invention, the method further comprises the step of encoding at least one of the difference frames of stream A2B using a block refresh mechanism.

According to a feature in the separate embodiment of the method of the present invention, the block refreshing mechanism used on the at least one difference frame is selected from the group consisting of Intra-Block Refresh and GOB intra code.

### BRIEF DESCRIPTION OF THE DRAWINGS

The invention is herein described, by way of example only, with reference to the accompanying drawings, wherein:

FIG. 1 illustrates an exemplary use of the method of the present invention;

FIG. 2 shows in a block diagram the general sequence of steps of the method of the present invention.

FIG. 3 shows the results of switching between two streams using the method of the present invention in terms of PSNR vs time on a “Foreman” video sequence;

### DESCRIPTION OF THE PREFERRED EMBODIMENTS

The present invention is of a method for scalable multi-level video coding that uses a combination of switch frames between compressed video streams and a block refresh mechanism on some, or preferably all, Inter-frames of each stream. A key innovative step of the method of the present invention is the use of Intra-block Refresh on the Inter-frames of the original streams and optionally on the switch streams in order to decrease the propagation of errors. IBR is a method normally used in P-frames to encode some of the frame not as difference from the previous frame, but as independent information. This method enables to use small sized switch frames with almost no degradation in the movie quality. IBR is commonly used for error resilience in an error prone environment. IBR is also known as “GOB intra code” when used in H.26L.

Specifically, the present invention can be used to solve the scalability problem in streaming video, by providing an innovative way for switching between two (or more) independently encoded streams at any time, at a single frame resolution, instead of having to wait for a key-frame at the “switched to” stream. This results in a “mixed stream” that is viewed by the decoding mechanism as a single independent stream. For example, two streams independently encoded using the MPEG-4 Visual Simple Profile at bit-rates of 20 and 40 Kbps, after activating the proposed method, will create an MPEG-4 Visual Simple Profile “mixed stream” at a variable bit rate between 20 to 40 kbps. The technique is applicable for any video compression method that uses inter-frame coding, and that has an IBR mechanism (e.g. MPEG1, 2, 4, H.263, and HT.24L etc.). While both the application of IBR on various frames of a stream and the use of switch streams are known separately, there is no prior art method that advantageously combines these two features to accomplish reduced noise, and economical and fast scalable streaming video.

The principles and operation of a method for scalable multi-level video coding according to the present invention may be better understood with reference to the drawings and the accompanying description.

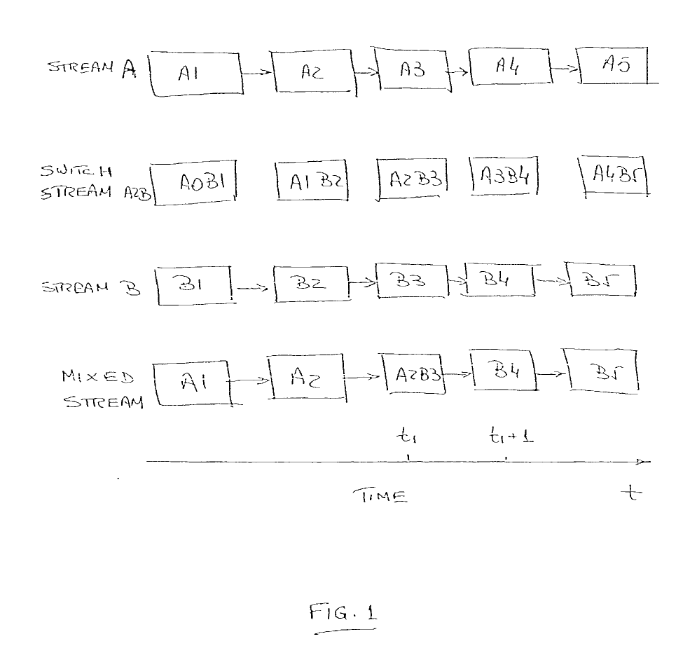

Referring now to the drawings, FIG. 1 illustrates an exemplary use of the method of the present invention. The method creates a switch Stream between every two independently encoded streams, for example a switch stream A2B between a first encoded stream A and a second encoded stream B, so that each frame in switch stream A2B at a time t, represents a difference frame (P-frame) between a source frame from stream A and a target frame from stream B. Each stream includes a series of frames (both Intra and Inter-frames). In FIG. 1, stream A is shown starting with a frame A1, and stream B is shown starting with a frame B1. Note that switch stream A2B is shown starting with a frame A0B1, although no A0 frame is shown in stream A. Similarly, a stream B2A (not shown) representing a switch stream from stream B to stream A can be created by exchanging the source and target frames. Henceforth, A2B is meant to represent any switch stream between two independently compressed video streams.

In the example of FIG. 1, we assume a situation in which a server transmits a video stream (of stored or live frames) to a client. At the beginning the server uses frames from stream A (i.e. frames A1, A2). At some time t₁, the bandwidth adaptation mechanism decides to switch into stream B. At that time, a frame A2B3 from switch stream A2B at time ti is transmitted to the client immediately followed by frames from stream B, starting at time t₁+1 (i.e. frames B4, B5, etc.). This process is repeated each time a stream is switched.

In addition, and unlike in prior art techniques, certain blocks of the Inter-frames in the original streams A and B are chosen, and then encoded as Intra-blocks using preferably the IBR method, which means that they are encoded independently from other blocks, and can be decoded with no reference to the previous frame. The IBR mechanism, which preferably is applied on all of the Inter-frames, reduces the noise introduced into a movie by every switch frame from the switch stream. This use of IBR has the effect that noise introduced to the stream by the switch frames is cancelled by the Intra-blocks. It is emphasized that although in the most preferred mode, the IBR is performed on all Inter-frames, the method will work also if IBR is applied to only one or a few of the Inter-frames, or to any combination of Inter-frames and other type of frames in a stream. Any commonly used IBR method known in the art can be used for the purposes of the present invention. for example the GOB intra code used in H.26L.

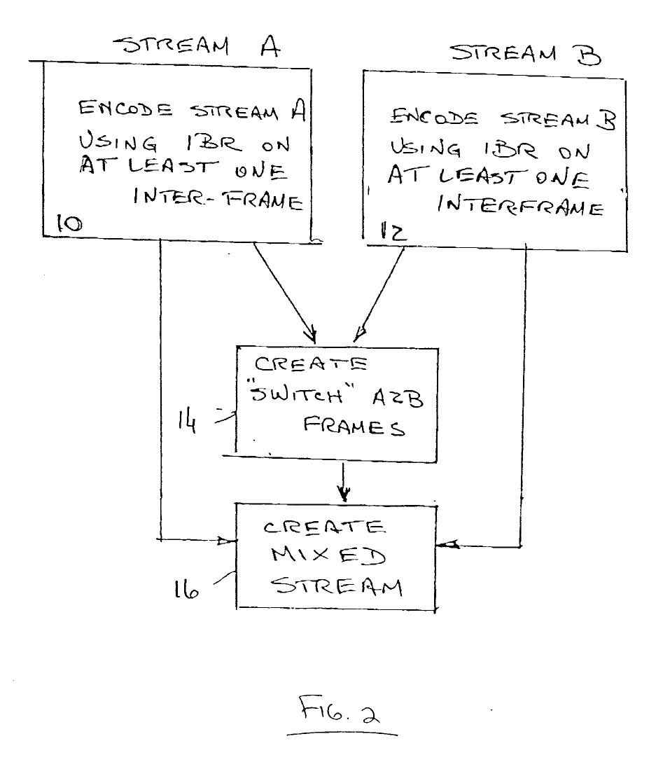

FIG. 2 shows in a block diagram the general sequence of steps of the method of the present invention. Two streams, A and B, are compressed, and at least one Inter-frame in each stream is encoded using preferably an Intra-Block Refresh mechanism (blocks 10 and 12 respectively). Preferably, IBR is performed on all Inter-frames. Optionally, IBR is performed on other types of frames (e.g. Intra-frames) as well. Switch frames A2B are then formed using a source frame from stream A and a target frame from stream B (block 14). The switch frames are thus difference frames, and IBR may be optionally performed on them as well (not shown). Finally, a mixed stream is formed using frames from streams A, B and A2B (block 10, 12 and 14). The combination of these two techniques (switch stream and Intra-Block Refresh) enables to transmit a video with a very small noise compared to that of the original streams (stream A and stream B) In a situation in which several independently encoded streams exists, a switch stream can be created between each selected pair of streams. Any frame in the switch stream may be created and coded either offline or in real-time, for use in VOD (Video-On-Demand) as well as in Live Broadcast. In summary, in a preferred embodiment, key steps of the the present method include:

i. providing a stream which only Inter-frames have blocks undergoing IBR, and encoded at a given quantization.

ii. providing a stream B, in which only Inter-frames have blocks undergoing IBR and encoded at a given quantization, and

iii. providing a switch frame A2B between A and B, so that each frame in switch stream A2B at a time t represents a difference frame (P-frame) between a source frame from stream A and a target frame from stream B, or

iv. providing a switch frame B2A between B and A, so that each frame in switch stream B2A at a time t represents a difference frame (P-frame) between a source frame from stream B and a target frame from stream A, and, optionally

v. performing IBR on the P-frames of switch streams A2B or B2A.

Although the sequence above shows the most preferred embodiment as using IBR performed only on the Inter-frames in each original stream and optionally in the switch streams, it is to be understood that the method of the present invention encompases the use of IBR on fewer than all Inter-frames in each stream, as well as the optional use of IBR on other frames in each original stream.

A major advantage of the present invention is that, in contrast with prior art methods that use switch frames, the method described herein provides, for the same video quality level, switch frames that much smaller. In particular, in comparison with the Farber and Girod method above, the present method provides switch frames up to several hundred times smaller than those of Farber and Girod. This great improvement and advantage of the present invention is achieved through the combination of a switch stream and IBR performed preferably on all the Inter-frames of each stream. The large switch frames of the Farber and Girod method make it unwieldly, in contrast with the usefulness of the present invention.

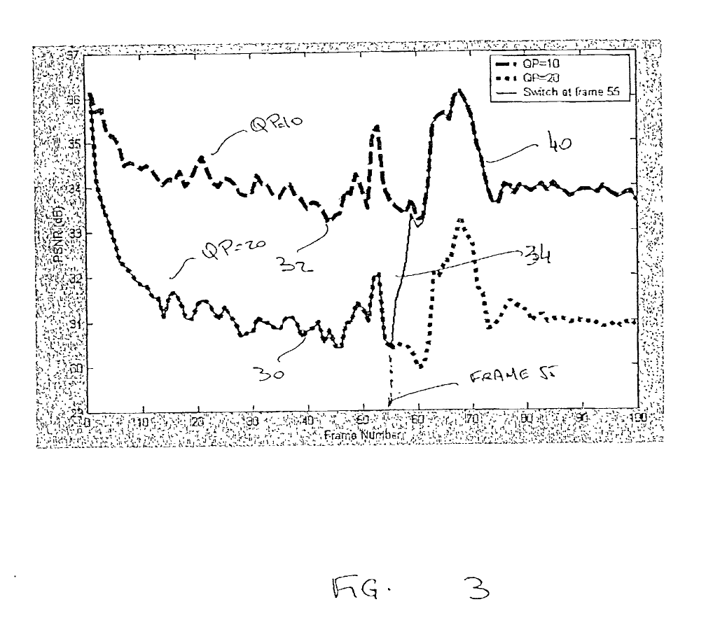

FIG. 3 shows the results of switching between two streams using the method of the present invention in terms of peak signal to noise ratio (PSNR) vs. time on a “Foreman” video sequence. The “Foreman” video has been tested under the multi-level method with a switching stream, to enable a switch from a low quality stream 30 encoded with a fixed quantization Qₚ of 20, into another, higher quality stream 32 encoded with a fixed quantization Qₚ of 10. In FIG. 3, the switch to the 55^{th} frame of higher quality stream 32 occurs using a switch frame 34 with quantization 10. A mixed stream 40 received by the client shows total quality merge with (almost the same PSNR values as) original higher quality stream 32. A comparison of the results presented in FIG. 3 herein with the results presented in FIG. 1 of Farber and Girod above shows that, in the method of the present invention, the noise (or mismatch error) is reduced significantly without having to use a smaller Qₚ. The PSNR results indicates that the combined use of switch frames with the Intra-Block Refresh mechanism applied to (preferably) all Inter-frames in each original stream enables the use of a switch frame encoded with a large Q_{P}, while still maintaining a high quality movie, something practically impossible with prior art switch-frame methods.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is

1. A method for streaming video in a varying bandwidth through scalable multi-level video coding, comprising:
a. providing at least two compressed video streams, each said stream including a respective plurality of Inter-frames,
b. within each said compressed video stream, encoding at least one Inter-frame of each said respective plurality at a respective quantization using a block refresh mechanism,
c. creating at least one switch frame between any pair of said compressed video streams, and
d. creating a mixed stream using said any pair of said compressed streams and said at least one switch frame, whereby the switching between said pair of compressed streams can be performed at any time at a single frame resolution, thus adjusting the streamed video to the bandwidth without degrading the video quality.

2. The method of claim 1, wherein said encoding includes encoding said at least one Inter-frame using Intra-Block Refresh.

3. The method of claim 2, wherein said encoding includes encoding said at least one Inter-frame using GOB intra code in H.26L.

4. The method of claim 2, wherein all said Inter-frames are encoded using Intra-Block Refresh.

5. The method of claim 3, wherein all said Inter-frames are encoded using GOB intra code in H.26L.

6. The method of claim 1, wherein said video streams include stored video frames.

7. The method of claim 1, wherein said video streams include live video frames.

8. The method of claim 1, wherein said step of providing at least two compressed video streams includes providing a first encoded stream A having a first plurality of frames, and a second encoded stream B having a second plurality of frames, and wherein said step of creating at least one switch frame between any pair of said compressed video streams includes creating a switch stream A2B between said A and B streams so that each frame in said switch stream A2B at a time t represents a difference frame between a source frame from said stream A and a target frame from said stream B.

9. The method of claim 8, optionally further comprising the step of encoding at least one of said difference frames of stream A2B using a block refresh mechanism.

10. The method of claim 9, wherein said block refreshing mechanism is selected from the group consisting of Intra-Block Refresh and GOB intra code.
